(19) United States
(12) Patent Application Publication
(10) Pub. No.: US 2011/0109121 A1
(43) Pub. Date: May 12, 2011

(54) ROOF AND GAP FAIRING FOR THE AERODYNAMIC DRAG REDUCTION OF TANKER TRUCKS

(75) Inventors: Kambiz Salari, Livermore, CA (US); Jason M. Ortega, Pacifica, CA (US)

(73) Assignee: Lawrence Livermore National Security, LLC, Livermore, CA (US)

(21) Appl. No.: 12/944,647

(22) Filed: Nov. 11, 2010

Related U.S. Application Data
(60) Provisional application No. 61/260,266, filed on Nov. 11, 2009.

(51) Int. Cl. B62D 35/00

(52) U.S. Cl. 296/180.2

(57) ABSTRACT

A fairing apparatus for reducing aerodynamic drag of a tanker in a freestream, and including a fairing body with a roof section, and left and right side sections connected to and extending below the roof section. Fasteners, for example, mount the fairing body on a cab of the tanker so that the roof, left, and right side sections extend from the roof, left and right side surfaces, respectively, of the cab towards a cylindrical tank carried behind the cab to reduce the gap between the cab and the tank and impede cross-flow therethrough, and the fairing surfaces of the roof, left, and right side sections are angled and preferably curvilinearly contoured to redirect airflow from the top and side surfaces of the cab to the curvilinearly contoured top and side surfaces of the tank to compensate for a profile mismatch between the cab and the taller and/or wider tank.

### CLAIM OF PRIORITY IN PROVISIONAL APPLICATION

This application claims the benefit of U.S. provisional application No. 61/260,266 filed Nov. 11, 2009, entitled, “Aerodynamics of a Cryogenic Semi-Tanker” by Jason Ortega et al, incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to aerodynamic drag reduction methods and devices. The invention relates more particularly to a roof and gap fairing apparatus for reducing the aerodynamic drag of tanker trucks having a substantially cylindrical tank behind a cab section with a gap therebetween.

### BACKGROUND OF THE INVENTION

It is well known in the art of vehicle design that the fuel consumption of a vehicle associated with its movement is directly related to certain aerodynamic characteristics of the vehicle, such as the aerodynamic drag of the vehicle expressed as the drag coefficient, Cd. As the aerodynamic drag experienced by a vehicle increases, the fuel costs also correspondingly increase due to the greater energy required to overcome the drag. For example, for a vehicle traveling 70 mph on a roadway, approximately 65% of the total fuel consumption of its engine is used to overcome aerodynamic drag. Thus, even a slight reduction in the aerodynamic drag coefficient of the vehicle can result in a significant improvement in fuel economy.

Tanker trucks (or simply “tankers”) are a particular type of bluff body vehicle known to have high drag coefficients. Tanker trucks are motor vehicles designed to transport liquefied loads, dry bulk cargo, or gases in cylindrical or substantially-cylindrical tanks which are positioned behind a cab section of the vehicle with a gap between the cab section and a front surface of the tank. Tanker trucks include both unibody vehicles and multi-unit/articulating vehicles such as semi-tanker trucks (or simply “semi-tankers”) having a tractor hitched with one or more tanker trailers.

FIGS. 1-3 illustrate a conventional semi-tanker known in the art, generally indicated at reference character 10, having a tractor 11 and a tanker trailer 12 hitched to and towed by the tractor 11. The tractor 11 has a cab section 11′ with a substantially vertical and rear-facing base surface 15 (or simply “base” or “cab base”). The tanker trailer 12 includes a substantially cylindrical tank 13 having a front surface 14 which faces the cab base 15, a top surface 18, and side surfaces 19. And the cab section 11′ and the front surface 14 of the tank 13 are separated by a gap 16 characterized by a gap distance b₀. As can be seen in FIG. 2, the front profile of the substantially cylindrical tank 13 as viewed along a longitudinal axis of the tank may oftentimes be greater (i.e. taller and/or wider) than the cab base 15 such that the curvilinear top surface 18 of the tank 13 is situated higher than an upper surface 21 of the cab (i.e. cab roof surface), and the curvilinear left and right side surfaces 19 and 20 of the tank 13 are situated wider apart than left and right side surfaces 22 and 23, respectively, of the cab section 11′. This mismatch between the profiles of the cab section and the tank can increase aerodynamic drag by direct flow impingement in the freestream.

Additionally, while the airflow of the freestream ideally separates off of the tractor cab 11′ and completely reattaches downstream onto the tanker trailer 12, the presence of the gap 16 can entrain the airflow separating from the cab section 11′ into the gap to produce gap drag, an effect which increases the overall drag of the vehicle. This is illustrated in FIG. 3 showing the semi-tanker 10 in a freestream, e.g. the semi-tanker 10 is moving forward. If the gap is large enough, when a semi-tanker is traveling along a road a crosswind can enter into the gap, decreasing the pressure on the base surface of the tractor cab and increasing the pressure on the front surface of the tank. Both of these pressure changes produce gap drag. One means of mitigating gap drag is to reduce the distance between the base of the tractor and the front of the tanker. However, because the axle loading of the tractor is fixed by the load distribution of the tanker trailer, reducing the gap size cannot be achieved by simply moving the tanker trailer closer to the cab base.

With hundreds of thousands of semi-tankers currently in operation in the U.S. alone, the need for reducing the aerodynamic drag of such semi-tankers and other types of bluff-bodied tanker trucks traveling at, for example, highway speeds are compelling and widely recognized. It would therefore be advantageous to provide a simple cost-effective aerodynamic drag reduction fairing apparatus which impedes cross-flow through the gap and compensates for the profile mismatch between the cab base and the front of the tank, to streamline the freestream transition across the gap.

### SUMMARY OF THE INVENTION

One aspect of the present invention includes a fairing apparatus for reducing aerodynamic drag of a tanker truck in a freestream, the tanker truck of a type carrying a substantially cylindrical tank located behind a cab section with a gap therebetween, the fairing apparatus comprising: a fairing body having a roof section, and left and right side sections connected to and extending below left and right sides, respectively, of the roof section, said roof section having a roof fairing surface positively inclined towards a trailing end of the fairing body, and said left and right side sections having left and right side fairing surfaces, respectively, which diverge from each other towards the trailing end of the fairing body; and means for mounting the fairing body to the cab section so that the roof fairing surface is positively inclined from a roof surface of the cab section toward a top surface of the tank, and the left and right side fairing surfaces diverge from left and right side surfaces, respectively, of the cab section toward left and right side surfaces, respectively, of the tank, for streamlining the freestream transition across the gap.

The present invention is directed to a fairing apparatus for reducing aerodynamic drag on a tanker truck, and is particularly designed and intended for use with tanker trucks of a type having a substantially cylindrical transport tank carried behind a cab section of the vehicle with a gap typically present between the tank and the cab section. It is appreciated that a “substantially cylindrical” tank is one having a curvilinear/round cross-section along its longitudinal axis, including but not limited to a circular cross-section or oval cross-section.

In particular, the fairing apparatus includes a fairing body having two primary sections: a roof section, and left and right side sections connected to and extending below left and right sides, respectively, of the roof section. The roof section has a roof fairing surface positively inclined towards a trailing end of the fairing body. And the left and right side sections have left and right side fairing surfaces, respectively, which diverge from each other towards the trailing end of the fairing body. The angled fairing surfaces are all intended to compensate for the height/width/shape mismatch (i.e. profile mismatch) between the tractor and tanker as viewed along a longitudinal axis of the vehicle, to smoothly redirect and streamline the flow to the top and sides of the tanker. Moreover, the roof fairing surface is also preferably curvilinearly contoured, i.e. rounded, so as to have a curvilinear cross-section at the trailing end that is substantially similar to the top surface of the tank, and the left and right side fairing surfaces are also each preferably curvilinearly contoured so as to have a curvilinear cross-section at the trailing end that is substantially similar to left and right side surfaces, respectively, of the tank. It is appreciated, however, that the fairing shape and contour is not limited to those shown in the figures; various alternative shapes are possible and anticipated as part of the present invention depending on either the flow patterns to be mitigated in the gap or the design constraints. The fairing body is constructed of a rigid preferably lightweight material known in the art, such as any variety of rigid plastics, aluminum, fiberglass, composites, etc. And the fairing body may be fabricated employing various methods known in the art, such as for example injection molding, to produce fairing surfaces of any shape and contour, especially a streamlined curvilinear contour.

The fairing apparatus also includes means for mounting the fairing body to the cab section (e.g. the cab roof and base) which may include various methods, mounting hardware, fasteners, or securing implements or devices known in the art to releasably or fixedly connect the fairing body to the cab section, such as for example, screws, bolts, hooks, latches, hook and loop, ties, clamps, welds, suspension wire, etc. In particular, the mounting devices are configured to mount the fairing body so that the roof fairing surface is positively inclined from a roof surface of the cab section toward a top surface of the tank, and the left and right side fairing surfaces diverge from left and right side surfaces, respectively, of the cab section toward left and right side surfaces, respectively, of the tank, to compensate for the profile mismatch. In one example embodiment, the means for mounting the fairing body to the cab section positions at least a portion of the roof fairing surface and the left and right side fairing surfaces to the rear of the cab base to reduce the gap, while still allowing the vehicle to articulate, such as during loading and unloading operations.

In this manner, the roof fairing section compensates for the height mismatch between the cab and tanker by smoothly redirecting the flow from the cab roof onto the top of the tanker, and preventing the flow from entering into the gap from the cab roof. Similarly, the left and right fairing sections prevent the flow from entering into the gap from the cab sides, as well as compensating for the width mismatch between the cab and the tanker by smoothly redirecting the flow from the cab sides to the sides of the tank. Computational fluid dynamics simulations of a full-scale tractor and tanker have demonstrated that the roof and gap fairing decreases the amount of cross-stream flow in the gap and can significantly reduce the aerodynamic drag of the semi-tanker as the gap size is reduced.

### BRIEF DESCRIPTION OF THE DRAWINGS

The accompanying drawings, which are incorporated into and form a part of the disclosure, are as follows:

FIG. 1 is a side view of a convention semi-tanker known in the art.

FIG. 2 is a front view of the semi-tanker of FIG. 1.

FIG. 3 is a top view of the semi-tanker of FIGS. 1 and 2 in a freestream, illustrating cross-flow through the gap.

FIG. 4 is a side plan view of an example embodiment of the fairing apparatus of the present invention.

FIG. 5 is a top plan view of the fairing apparatus of FIG. 4.

FIG. 6 is a front plan view of the fairing apparatus of FIG. 4.

FIG. 7 is a rear plan view of the fairing apparatus of FIG. 4.

FIG. 8 is a perspective view of the fairing apparatus of FIG. 4 mounted on a tractor cab of a semi-tanker.

FIGS. 9A-D are side views of four embodiments of the fairing apparatus of the present invention mounted on the semi-tanker of FIG. 1, with the four embodiments having different fairing lengths extending across the gap.

FIG. 10 is a graph of experimental measurements of coefficient of drag, C_{d}, of the semi-tanker as a function of gap distance, b, normalized against a reference gap distance, b₀.

### DETAILED DESCRIPTION

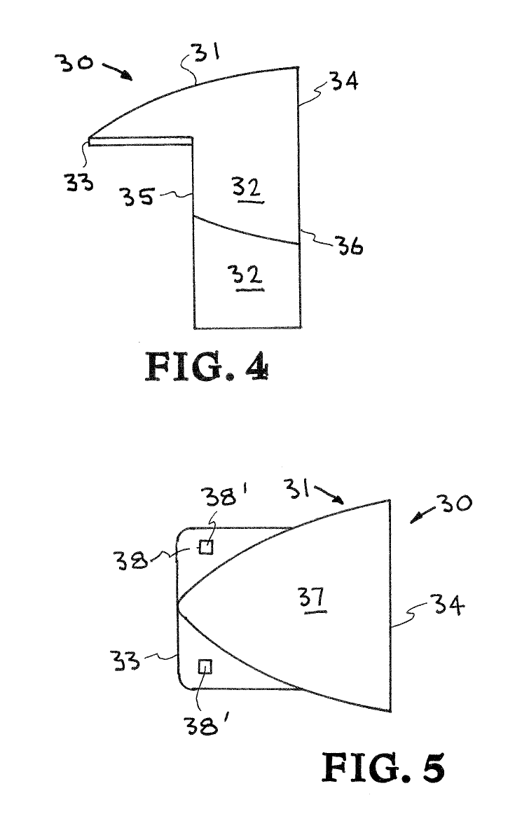

Turning now to the drawings, FIGS. 4-8 show an exemplary first embodiment of the fairing apparatus of the present invention for reducing aerodynamic drag of tanker trucks in a freestream. In particular, the fairing apparatus includes a fairing body 30 having a roof section 31, and left and right side sections 32 and 39, respectively. The roof section 31 is shown having a leading end 33 and a trailing end 34, and the left and right side sections are each shown having a leading end 35 and a trailing end 36. The trailing ends 34 and 36 are shown aligned with each other and may be considered the trailing end of the fairing body, while the leading end 33 of the roof section is shown at a forward position relative to the leading end 35 of the left/right side sections. In the alternative, it may be appreciated that the leading ends 33 and 35 may also be aligned with each other similar to the trailing ends 34, 36. In any case, the left and right side sections are connected to and extend below the left and right sides, respectively, of the roof section. The roof section 31 has a roof fairing surface positively inclined (sloping upwards) from the leading end 33 towards the trailing end 34, and the left and right side sections 32 and 39 have left and right side fairing surfaces, respectively, which diverge from each other from the leading end 35 towards the trailing end 36.

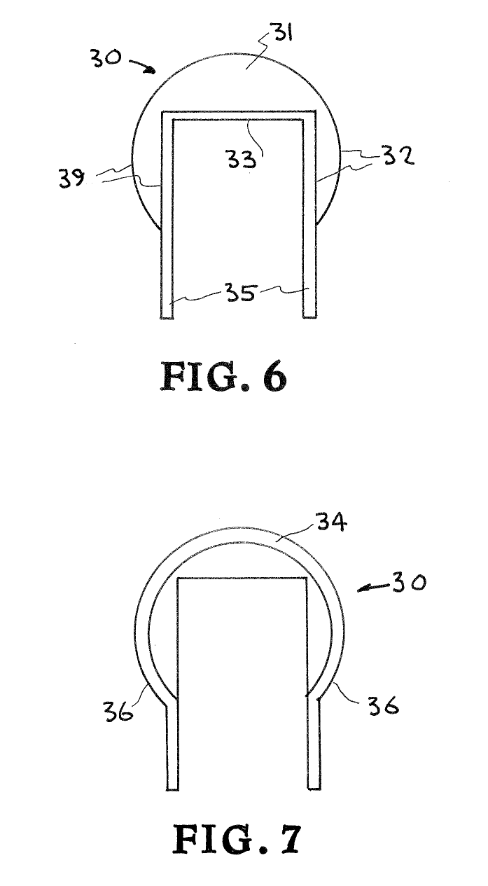

As can be best seen in FIGS. 6 and 7, the roof fairing surface may be curvilinearly contoured so as to have a curvilinear cross-section at the trailing end 34. Furthermore, the curvilinear cross-section at the trailing end 34 of the roof fairing surface may be configured to be substantially similar in size and shape to the top surface of the tank. Similarly, the left and right side fairing surfaces may also each be curvilinearly contoured so as to have a curvilinear cross-section at the trailing end 36. And furthermore, the curvilinear cross-section at the trailing end 36 of the left and right side fairing surfaces may be configured to be substantially similar in size and shape to the left and right side surfaces, respectively, of the tank. As shown in the Figures, the curvilinear cross-sections of the roof section and the left and right side sections preferably form a continuous curve. For the left and right side sections 32 and 39, only a portion (e.g. an upper portion in line with the tank) of these sections is shown having a curvilinear contour, while other portions (e.g. a lower portion at a lower elevation and therefore not in line with the tank) may be flat.

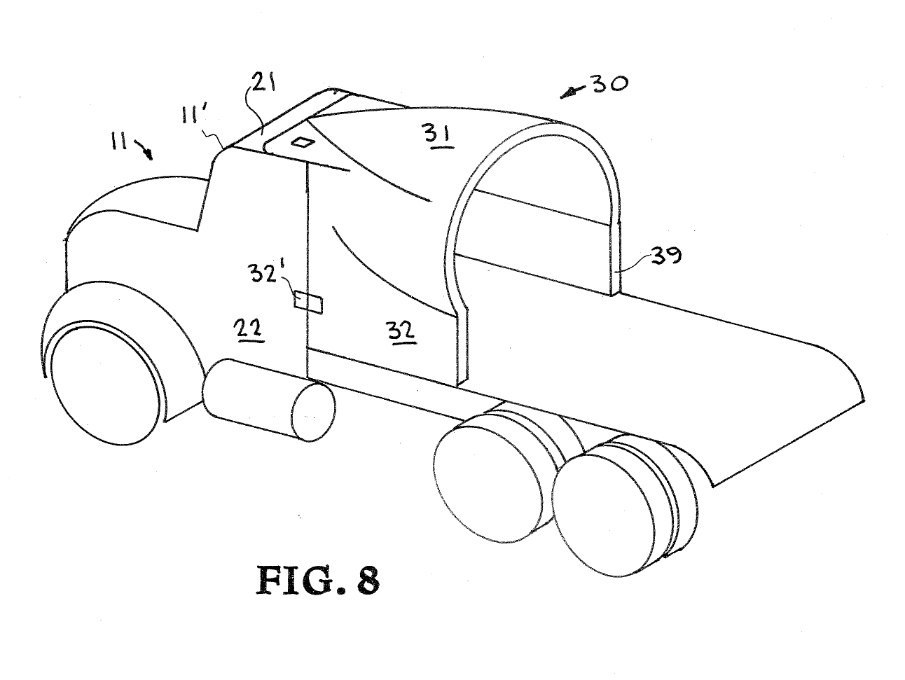

In FIG. 5, a top view of the fairing body 30 shows the roof section 31 having a curvilinear contoured (streamlined) section 37 shown converging to a forward nose, and two flat sections 38 which may be used for mounting the fairing body to the cab roof 21 (see FIG. 8) via upper mounts 38′. Side mounts 32′ are also shown in FIG. 8 connecting the left and right side sections to the sides 22 of the cab section 11′ of the tractor 11. FIG. 8 also shows the leading end of the roof section 31 positioned over the cab roof, while the leading end of the left and right side sections 32, 39 are connected to and positioned behind the cab base. It may be appreciated in the alternative that the leading end of the roof section may also be positioned behind the cab base, such as for example by being connected to a rear edge of the cab roof, and that the leading end of the left and right side sections may be also be positioned forward of the cab base alongside the cab side surfaces, though not shown in the figures. Moreover, for some sufficiently short gap distances, the roof section and left and right side sections of the fairing body may all be positioned forward of the cab base while still angled to direct airflow to the top and side surfaces of the tank. For most semi-tanker arrangements having substantial gap distances, however, mounting of the fairing body to the cab section or other part of the tractor would position some portion of the roof, left, and right side sections behind and to the rear of the cab base to reduce the gap to reduce cross-flow therethrough.

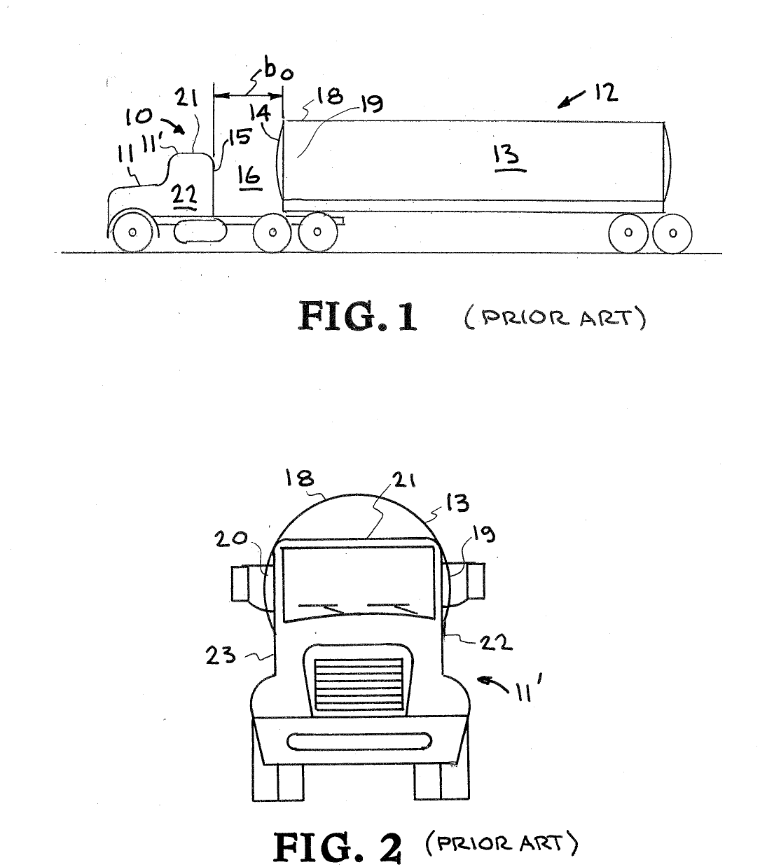

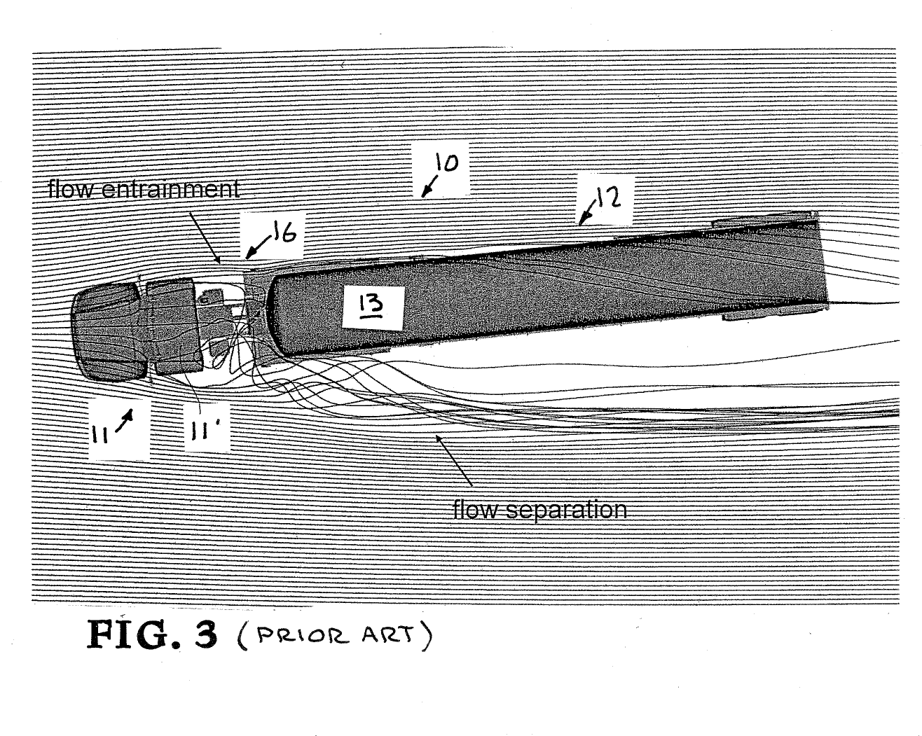

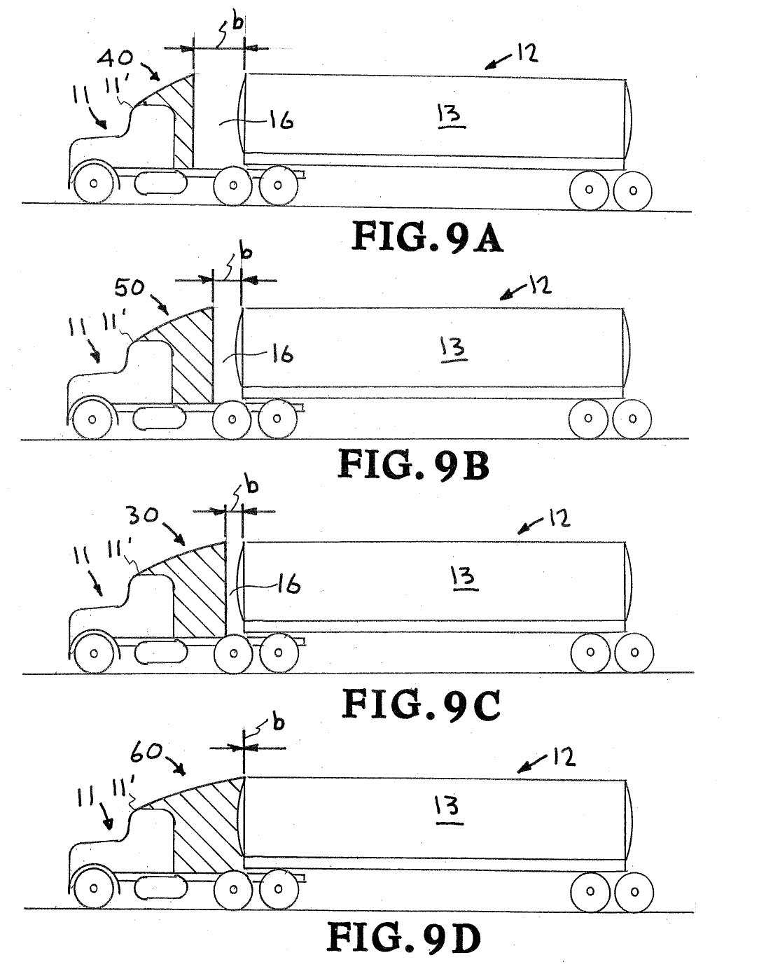

FIGS. 9A-D show four embodiments (40, 50, 30, and 60, respectively) of the fairing apparatus of the present invention, including the first embodiment 30 discussed in FIGS. 4-8 and shown in FIG. 9C. Each of the four embodiments are shown mounted on the same conventional semi-tanker of FIGS. 1-3 for comparative purposes, and in particular are each mounted to the cab section 11′ of a tractor 11 which is hitched with a tanker trailer 12 carrying a tank 13. A gap 16 is also shown between the trailing end of the fairing body and a front face 14 of the tank, and characterized by a gap distance b. Notably, FIGS. 9A-D together show a progressive increase in fairing length from embodiment 40 (shortest) in FIG. 9A, to 50 in FIG. 9B, to 30 in FIG. 9C, to 60 (longest) in FIG. 9D. Inversely, the gap distance b is shown progressively decreasing from FIG. 9A to FIG. 9D where b≈0. While a large gap distance between the tank and the fairing body (and thus a shorter fairing body) would enable sufficient clearance for the tanker trailer 12 to freely articulate with respect to the cab and tractor, it is appreciated that even a sufficiently long fairing body which completely bridges the gap may be employed without necessarily restricting articulation of the trailer. As can be seen in FIGS. 9A-D, the roof fairing section is angled to have a positive incline from the roof surface of the cab towards the top surface of the tank.

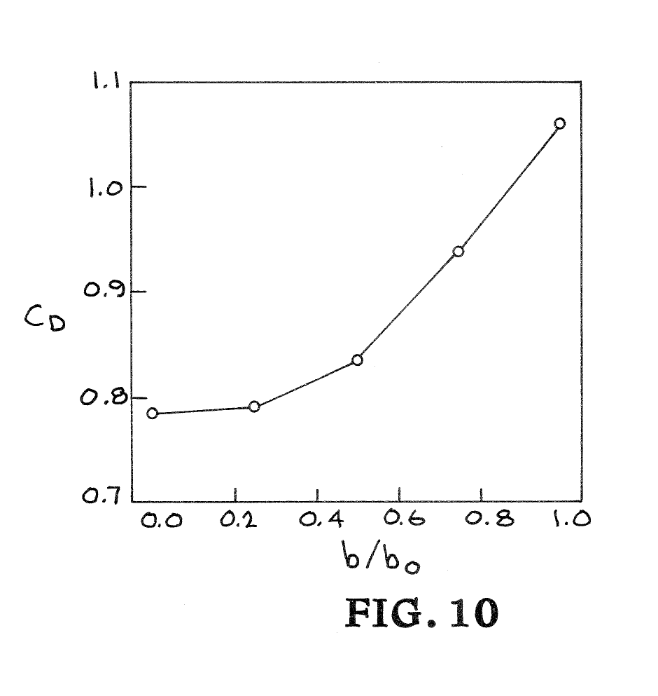

FIG. 10 shows a graph of computational fluid dynamics simulation measurements of coefficient of drag, C_{d}, of a semi-tanker outfitted with the four embodiments of the fairing apparatus of the present invention discussed in FIGS. 9A-D, and a fifth configuration without a fairing apparatus i.e. the semi-tanker of FIG. 1. In particular, the C_{d} is graphed as a function of gap distance, b, normalized against a reference gap distance, b₀, i.e. where a fairing apparatus is not used, and expressed as the scalar b/b₀. Five values were plotted, including b/b₀=1.00 for the FIG. 1 configuration absent a fairing apparatus, b/b₀=0.75 for the FIG. 9A configuration, b/b₀=0.50 for the FIG. 9B configuration, b/b₀=0.25 for the FIG. 9C configuration, and b/b₀=0.00 for the FIG. 9D configuration. As can be seen, the drag coefficient decreases as the tractor-tanker gap becomes smaller.

While particular embodiments have been described and or illustrated, such are not intended to be limiting. Modifications and changes may become apparent to those skilled in the art, and it is intended that the invention be limited only by the scope of the appended claims.

We claim:

1. A fairing apparatus for reducing aerodynamic drag of a tanker truck in a freestream, the tanker truck of a type carrying a substantially cylindrical tank located behind a cab section with a gap therebetween, the fairing apparatus comprising:
a fairing body having a roof section, and left and right side sections connected to and extending below left and right sides, respectively, of the roof section, said roof section having a roof fairing surface positively inclined towards a trailing end of the fairing body, and said left and right side sections having left and right side fairing surfaces, respectively, which diverge from each other towards the trailing end of the fairing body; and
means for mounting the fairing body to the cab section so that the roof fairing surface is positively inclined from a roof surface of the cab section toward a top surface of the tank, and the left and right side fairing surfaces diverge from left and right side surfaces, respectively, of the cab section toward left and right side surfaces, respectively, of the tank, for streamlining the freestream transition across the gap.

2. The fairing apparatus of claim 1,
wherein said means for mounting the fairing body to the cab section positions at least a portion of the roof fairing surface and the left and right side fairing surfaces to the rear of a base surface of the cab section to reduce the gap.

3. The fairing apparatus of claim 2,
wherein the roof fairing surface is curvilinearly contoured so as to have a curvilinear cross-section at the trailing end that is substantially similar to the top surface of the tank, and the left and right side fairing surfaces are each curvilinearly contoured so as to have a curvilinear cross-section at the trailing end that is substantially similar to left and right side surfaces, respectively, of the tank.
